(19) United States
(12) Patent Application Publication
(10) Pub. No.: US 2007/0222199 A1
(43) Pub. Date: Sep. 27, 2007

(54) ANTI-TIP MECHANISM FOR WHEELCHAIRS

(75) Inventor: Douglas Schattner, Limbach (DE)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(73) Assignee: Otto Bock HealthCare IP, Duderstadt (DE)

(21) Appl. No.: 11/689,268

(22) Filed: Mar. 21, 2007

(30) Foreign Application Priority Data
Mar. 25, 2006 (DE) 102006013910.0

(51) Int. Cl. B62D 49/08

(52) U.S. Cl. 280/755

(57) ABSTRACT

Anti-tip mechanism for wheelchairs having wheels on a rear axle. The mechanism includes left and right side sections that are each attached to an exterior end of the rear axle with a bracket. Each side of the mechanism extends perpendicular to the axle when the mechanism is in a functional position and parallel to the axle when in an idle position. The bracket is equipped with a hinge plate mounted at an angle; whether the angle is positive or negative depends on whether the bracket is part of the mechanism's left side or right side. A support arm is rotatably coupled to the hinge plate by a locking mechanism and includes a support roller at the other end. Release of the locking mechanism allows movement of the support arm between the functional and idle positions.

This patent application claims priority from German Patent Application No. 10 2006 013 910.0, entitled “KIPPSCHUTZ FÜR ROLLSTÜHLE,” filed on Mar. 25, 2006.

### TECHNICAL FIELD

This invention relates to anti-tip mechanisms for wheelchairs, in particular, wheelchairs with incorporated rear axle drive gears.

### BACKGROUND

A wheelchair is described in DE 92 17 764 U1, which has support rollers protruding from the back end over the drive gears as security against tipping. These support rollers hinder backward tipping of the wheelchair frame in the event of excessive acceleration of the wheelchair or when proceeding up an incline. The support rollers cannot be a very large distance from the ground, if they are to fulfill their support function. On the other hand, it must be possible for the wheelchair to climb a curb and for the chair stability to be controlled. In this case, a hinge is installed in the arm on which the support rollers are supported, which allows the support rollers to swivel around an axle mounted parallel to the rear axle of the chair. The rollers will then swivel in the forward direction.

For wheelchair transportation, in particular when the user must stow the chair in a vehicle by themselves, the anti-tip mechanism must be able to be folded up and therefore occupy as little space as possible. If the anti-tip mechanism is located under the seat, handling the wheelchair is more difficult in situations in which the wheelchair is to be lifted by the user who is sitting in the vehicle, because the wheelchair must be lifted over the user in order to be stowed on the passenger side.

### SUMMARY

In answer to this problem, the invention is based on the task of creating an anti-tip mechanism which may be taken from functional position to idle position in an easy manner and which will occupy as little space as possible.

The solution to the problem is an anti-tip mechanism which is attached to an exterior end of the rear axle and runs perpendicular to the axle when in its functional position and parallel to the axle in its idle position. This is connected with a bracket equipped with a hinge plate tending to angle α, which is positive or negative angle depending on which exterior end (right or left) of the rear axle the bracket is attached to.

Through this design, anti-tip protectors may be folded up parallel to the rear axle and will be folded over each other due to the oblique angles, so that they require a minimum of space. Because the anti-tip protectors run parallel to the rear axle, the space under the seat of the wheelchair is free.

By the immediate attachment onto the rear axle and the short hinge plate, the wheelchair users can fold up the anti-tip mechanism themselves, which makes operation significantly simplified.

The angle α is preferably within the 8-15° range and is most preferable 11°.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1: the back view of a wheelchair showing the anti-tip mechanism in accordance with the present invention in an idle position;

FIG. 2: a perspective exploded illustration of one side of the anti-tip mechanism;

FIG. 3: a view of the bracket with the hinge piece;

FIG. 4: a view pursuant to arrow IV in FIG. 3;

FIG. 5: a further view of the bracket of the anti-tip mechanism;

FIG. 6: a view of one side of the anti-tip mechanism;

FIG. 7: the top view of the anti-tip mechanism pursuant to arrow VII in FIG. 6;

FIG. 8: the side view of a wheelchair showing the anti-tip mechanism in the functional position;

FIG. 9: a perspective partial view the wheelchair in FIG. 8; and

FIG. 10: a partial back view of the wheelchair showing the anti-tip mechanism in the idle position.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

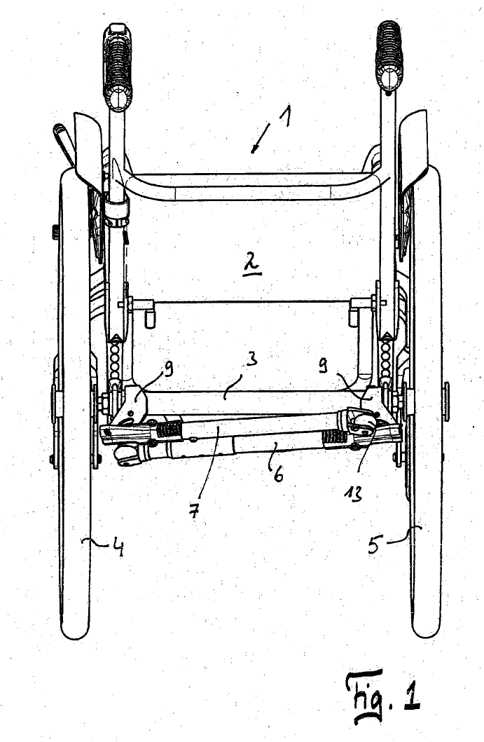

A wheelchair shown in FIG. 1 primarily consists of a seat (2) mounted on a frame (1) to which a foot rest (18) and at least one steerable front wheel (17) are connected. Wheels (4,5) are mounted on a rear drive axle (3) and each include a standard tire, rim and hub.

On the exterior ends of the rear axle (3) there is mounted an anti-tip mechanism (6,7) in accordance with the present invention. As shown in FIGS. 1 & 9, the anti-tip mechanism (6,7) includes a right side (6) and a left side (7), each of which is equipped with a small roller support wheel (13) on its lower end.

FIGS. 8 & 9 illustrate a functional position of the anti-tip mechanism (6,7), which protrudes to the rear from the drive axle (3) of the wheels (4,5) and which ends above the tire riser surface. If the wheelchair tips backward because the driver has, for example, applied an excessive drive force to the wheels (4,5), or if the wheelchair has hit an incline, the chair will be supported by the anti-tip mechanism (6,7) at the support wheels (13), whereby tipping over backward is prevented. If stairs must be negotiated or a curb must be climbed, the two sides of the anti-tip mechanism (6,7) may be moved out of the way into an idle position by swiveling them inward, such that one side folds over the other and they are generally parallel to the drive axle (3), as shown in FIGS. 1 & 10.

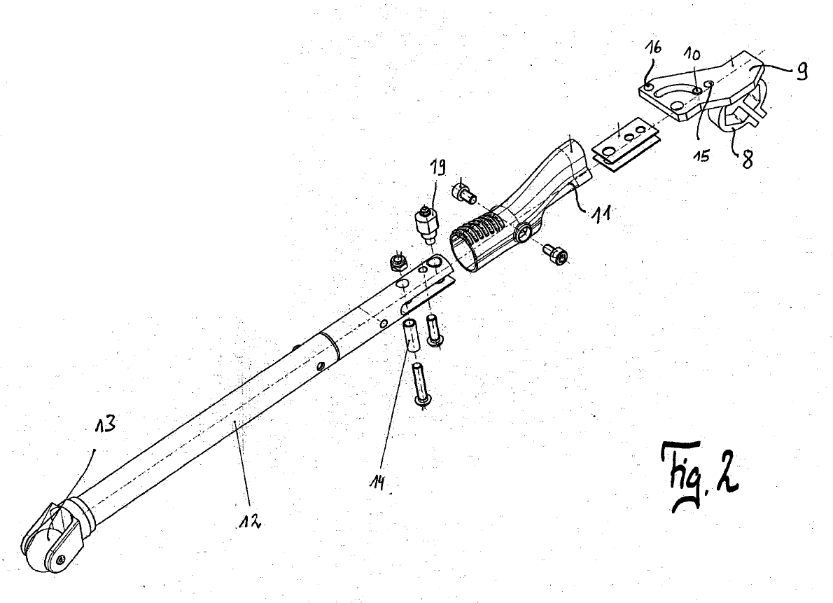

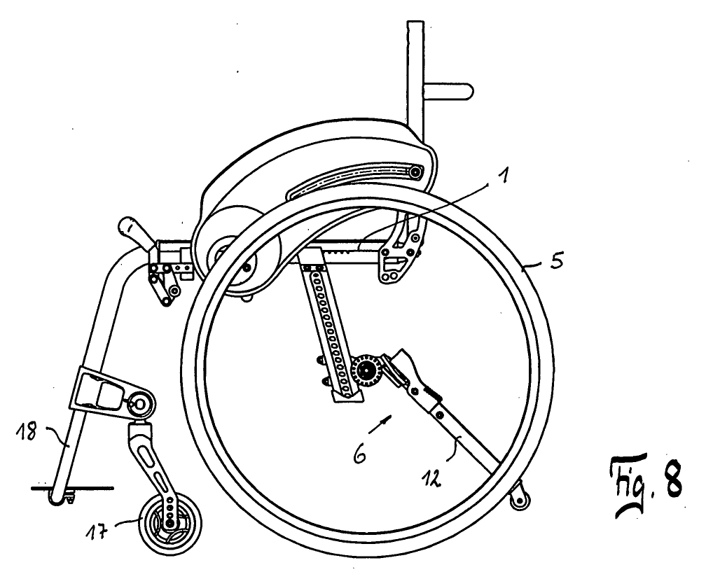

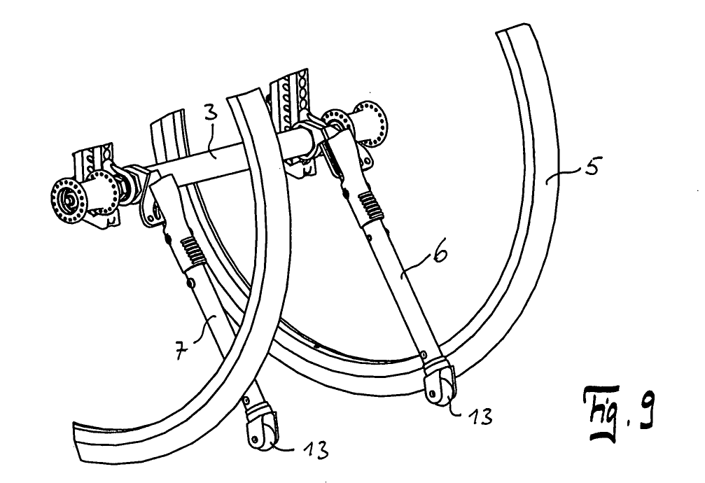

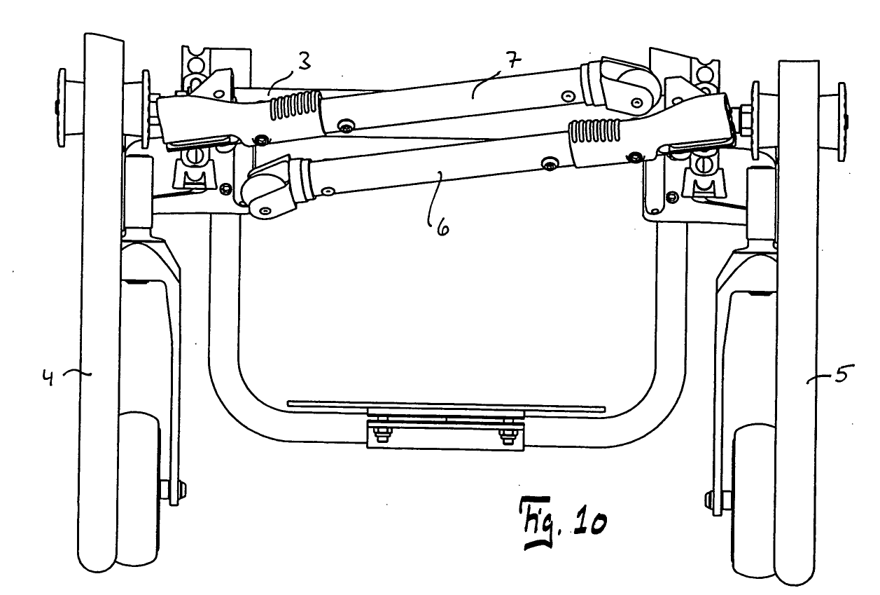

As shown in FIGS. 2 & 6, each side of the anti-tip mechanism (6,7) consists of a bracket (8) that mounts to an end of the rear drive axle (3). Each side of the anti-tip mechanism (6,7) also consists of a locking mechanism (11) and a support arm (12) that has one of the support wheels (13) mounted on its free end. As shown in FIGS. 3-7, each bracket (8) attaches to one of the locking mechanisms (11) and its support arm (12) by a hinge plate (9) that is attached to the bracket (8) at an angle α. In the hinge plate (9), there is an arc shaped slit (10), to which the support arm (12) is coupled by anchor (14). Lock drill holes (15,16) serve to secure the support arm (12) of each side of the anti-tip mechanism (6,7) in the functional or idle position via spring loaded anchors (19). In order to move the sides of the anti-tip mechanism (6,7) between the idle and functional positions, the locking mechanisms (11) are pushed, which releases the anchors (19) so that rotational movement of each support arm (12) relative to its hinge plate (9) is triggered.

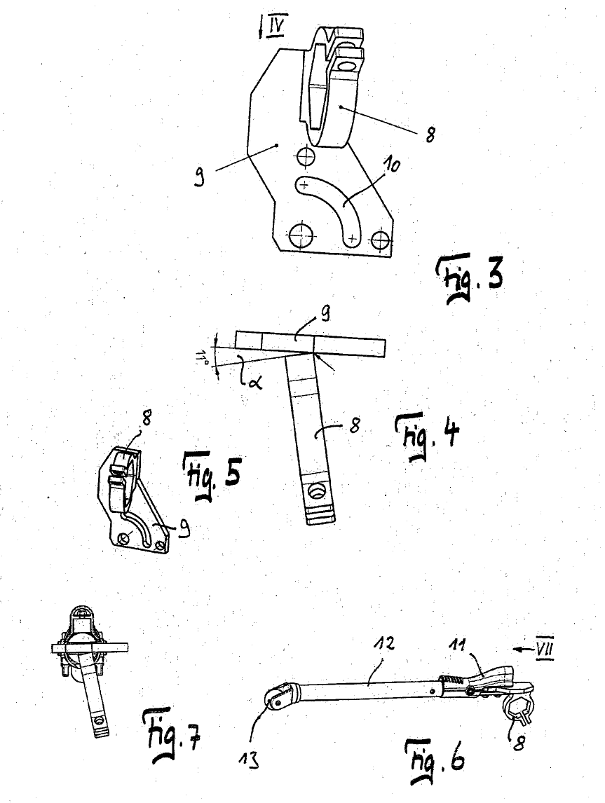

FIG. 4 illustrates how the hinge plate (9) is attached to the bracket (8) at a positive angle, preferably in a range of about 8-15° or about 11°. This figure shows the attachment apparatus for the left side of the anti-tip mechanism (7) to the rear axle (3). The attachment for the right side of the anti-tip mechanism (6) to the rear axle (3) is done in a mirror image, so that the angle α of about 11° is negative between the hinge plate (9) and the bracket (8). Otherwise, both sides of the anti-tip mechanism (6,7) are identically configured.

The hinge plate (9) is relatively short. Thus, each locking mechanism (11) is situated very close to the rear axle (3), which enables the wheelchair user to operate it on his/her own, in order to swivel the sides of the anti-tip mechanism (6,7) between the idle and functional positions, and not be dependent on outside help.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

I claim:

1. An anti-tip mechanism for wheelchairs having wheels mounted on a drive axle to prevent the wheelchair from tipping over backward, the anti-tip mechanism comprising:
left side and right side mechanisms, each of which comprises:
a bracket mountable to the drive axle of the wheelchair;
a hinge plate mounted to the bracket at an angle;
a support arm having first and second ends;
a locking mechanism moveably coupling the first end of the support arm to the hinge plate; and
a support wheel mounted to the second end of the support arm,
wherein the anti-tip mechanism is in an idle position when each support arm is positioned generally parallel and adjacent to the drive axle, and
wherein the anti-tip mechanism is in a functional position when each support arm is positioned generally perpendicular to the drive axle with the support wheel positioned above a surface upon which the wheelchair is supported.

2. The anti-tip mechanism of claim 1, wherein each support arm moves between the idle and functional positions by rotational movement relative to its hinge plate.

3. The anti-tip mechanism of claim 1, wherein each locking mechanism secures the support arm relative to the hinge plate until release of the locking mechanism provides rotational movement of the support arm relative to the hinge plate.

4. The anti-tip mechanism of claim 3, wherein each hinge plate comprises an arc-shaped slit and wherein the support arm is coupled to the hinge plate by an anchor within the slit.

5. The anti-tip mechanism of claim 4, wherein each locking mechanism comprises a spring loaded anchor which secures the support arm to the hinge plate, and wherein release of the spring loaded anchor by applying force to the locking mechanism against the spring results in rotational movement of the support arm as the support arm anchor moves from one end of the slit to the other end of the slit.

6. The anti-tip mechanism of claim 1, wherein the hinge plate mounting angle is within the range of about 8-15°.

7. The anti-tip mechanism of claim 7, wherein the hinge plate mounting angle is about 11°.

8. The anti-tip mechanism of claim 1, wherein the hinge plate mounting angle of the left side mechanism is a positive angle and of the right side mechanism is a negative angle.

9. The anti-tip mechanism of claim 8, wherein the opposite hinge plate mounting angles of the left and right side mechanisms enable the support arms to be folded over each other and thereby reduce space occupied by the anti-tip mechanism in the idle position.

10. The anti-tip mechanism of claim 1, wherein the hinge plate and bracket assembly of the right side mechanism is a mirror image of the hinge plate and bracket assembly of the left side mechanism.

11. The anti-tip mechanism of claim 1, wherein the left and right side mechanisms are configured to enable a user of the wheelchair to take the anti-tip mechanism between the idle position and the functional position by himself or herself.
